(19) United States
(12) Patent Application Publication
(10) Pub. No.: US 2024/0367479 A1
(43) Pub. Date: Nov. 7, 2024

(54) THERMAL CONDITIONING MODULE WITH ACCUMULATION DEVICE

(71) Applicant: VALEO SYSTEMES THERMIQUES, Le Mesnil-Saint-Denis (FR)

(72) Inventors: Julien Tissot, Le Mesnil-Saint-Denis Cedex (FR); Kamel Azzouz, Le Mesnil-Saint-Denis Cedex (FR); Moussa Nacer Bey, Le Mesnil-Saint-Denis Cedex (FR); Julio Guerra, Le Mesnil-Saint-Denis Cedex (FR)

(73) Assignee: VALEO SYSTEMES THERMIQUES, Le Mesnil-Saint-Denis (FR)

(21) Appl. No.: 18/688,789

(22) PCT Filed: Sep. 5, 2022
(86) PCT No.: PCT/EP2022/074654

§ 371 Date: Mar. 4, 2024

(30) Foreign Application Priority Data
Sep. 6, 2021 (FR) FR2109329

(51) Int. Cl. B60H 1/00; B60H 1/32

(52) U.S. Cl. CPC B60H 1/00342; B60H 1/3227; B60H 2001/00942

(57) ABSTRACT

A heat treatment module for a heat treatment system of a vehicle is disclosed. The heat treatment module includes a first heat exchanger, a second heat exchanger, and an internal heat exchanger. The first heat exchanger and the second heat exchanger both are configured to bring about an exchange of heat between a refrigerant fluid and a heat transfer liquid. The internal heat exchanger is configured to bring about an exchanger of heat between the refrigerant fluid, which is subjected to two different temperature levels in the heat treatment system. The heat treatment module includes an accumulation device configured to contain the refrigerant fluid. The internal heat exchanger includes a platform on which the accumulation device is disposed.

The present invention relates to the field of heat treatment systems within a vehicle, and more particularly concerns a heat treatment module within such heat treatment systems.

Motor vehicles are frequently equipped with a refrigerant fluid circuit and with at least one heat transfer liquid circuit, which are both used to contribute to the heat treatment of various zones or various components of the vehicle. It is notably known for the refrigerant fluid circuit and/or the heat transfer liquid circuit to be used to thermally treat an air flow sent into an interior of the vehicle equipped with such a circuit.

In another application of this circuit, it is known for the heat transfer liquid circuit to be used to cool components of the powertrain of the vehicle, such as an electrical storage device, the latter being used to supply energy to an electric motor capable of setting the vehicle in motion. The heat treatment system thus supplies the energy capable of cooling the electrical storage device when it is used.

The refrigerant fluid and the heat transfer liquid circulate within their respective circuit and interact with one another by means of a plurality of heat exchangers ensuring an exchange of heat energy between the two aforementioned fluids. In order to improve the compactness of the heat treatment system, several of these heat exchangers may be grouped together in one heat treatment module. Since motor vehicle manufacturers have the aim of continually improving their vehicles, one objective for improving such heat treatment modules is that of grouping together further elements of the heat treatment system within the heat treatment modules.

The present invention falls within this context by proposing a heat treatment module for a heat treatment system of a vehicle, comprising a first heat exchanger, a second heat exchanger and an internal heat exchanger, the first heat exchanger and the second heat exchanger both being configured to bring about an exchange of heat between a refrigerant fluid and a heat transfer liquid, the internal heat exchanger being configured to bring about an exchange of heat between the refrigerant fluid, which is subjected to two different temperature levels in the heat treatment system, characterized in that the heat treatment module comprises an accumulation device configured to contain the refrigerant fluid, the internal heat exchanger comprising a platform on which the accumulation device is disposed. Such a heat treatment module according to the invention therefore makes it possible to group together an accumulation device and three exchangers ensuring an exchange of heat either between the refrigerant fluid and the heat transfer liquid or within a refrigerant fluid circuit, as is the case for the internal heat exchanger. Such a configuration therefore makes it possible to integrate the accumulation device in the heat treatment module, thereby avoiding the installation of an accumulation device at a distance from the heat treatment module, and also the installation of pipes for connecting this accumulation device to the heat treatment module.

The first heat exchanger and the second heat exchanger ensure an exchange of heat between the refrigerant fluid and the heat transfer liquid in order to perform multiple functions that depend on a temperature of the refrigerant fluid. By way of example, within these heat exchangers, the heat transfer liquid can condense the refrigerant fluid. According to another example, the refrigerant fluid may cool the heat transfer liquid in order that the latter performs a heat treatment function for the components of the powertrain of the vehicle.

The internal heat exchanger is specific to the refrigerant fluid circuit. In other words, the internal heat exchanger allows an exchange of heat between two temperature levels of the refrigerant fluid in order to thermally regulate the refrigerant fluid and as a result optimize the thermal performance of the refrigerant fluid circuit.

While the refrigerant fluid is circulating within the heat treatment module, and more generally within the heat treatment system, said refrigerant fluid changes state several times, switching from a liquid state to a gaseous state and vice versa. The refrigerant fluid is thus in a two-phase state. However, the refrigerant fluid is made to circulate within the refrigerant fluid circuit by a compression device, which is only able to compress the refrigerant fluid in the gaseous state and there is a risk of damage if the refrigerant fluid circulates in the liquid state. The accumulation device therefore makes it possible to contain the refrigerant fluid in the liquid state in order that it does not continue to circulate to the compression device. The accumulation device thus ensures the protection of the compression device.

The accumulation device is disposed on the platform. The latter acts as mechanical support for the accumulation device, which can be connected to the platform by any fixing means. The platform should therefore have dimensions that make it possible to install and fix the accumulation device.

According to one feature of the invention, the internal heat exchanger comprises a body made up of a plurality of plates stacked along a stacking axis, the body being able to be inscribed in a projection onto a plane perpendicular to the stacking axis of the plates, a projection of the first heat exchanger and the second heat exchanger onto the plane perpendicular to the stacking axis of the plates of the internal heat exchanger being comprised in the projection of the body of the internal heat exchanger.

Plate exchangers are composed of a stack of plates, said plates being stacked along a stacking axis. When the refrigerant fluid circulates within the body of the internal heat exchanger, the refrigerant fluid, at two different temperatures, circulates within gaps between the plates in order for the exchange of heat to be possible. Advantageously, the disposition of the plates forms alternating circulations of the refrigerant fluid at a first temperature and the refrigerant fluid at a second temperature. Such alternating circulation ensures that the exchange of heat takes place correctly within the internal heat exchanger.

Incorporating the planes of projection of the heat exchangers within the plane of projection of the internal heat exchanger makes it possible to keep at least two dimensions of the heat treatment module equal to the dimensions of the internal heat exchanger. Such a configuration makes the heat treatment module more compact.

According to one feature of the invention, the platform of the internal heat exchanger extends beyond the projection of the body of the internal heat exchanger. Therefore, the platform is not integrated in the body of the internal heat exchanger and therefore also extends beyond the projection of the assembly of the two heat exchangers. This is a first embodiment of the platform of the heat treatment module according to the invention.

According to one feature of the invention, the platform is welded to the body of the internal heat exchanger. The platform may be produced outside the heat treatment module and be connected thereto afterwards. The connection can be made by welding, but any other fixing means is conceivable provided that it does not adversely affect the correct operation of the heat treatment module.

According to one feature of the invention, the plates of the internal heat exchanger have a zone forming the platform. Such a zone may for example be a continuation of the plates forming the platform. This configuration makes it possible to dispense with the connection of the platform to the body of the internal heat exchanger, with the zone of the plates extending out of the projection to delimit the platform.

According to one feature of the invention, the platform of the internal heat exchanger is comprised in the projection of the body of the internal heat exchanger. In other words, when the accumulation device is positioned on the platform, it can be at least partially inscribed inside a perimeter defined by the body of the internal heat exchanger. As a result, at least one of the heat exchangers of the heat treatment module should have reduced dimensions in order not to mechanically interfere with the accumulation device.

According to one feature of the invention, the platform is delimited on a first side by the first heat exchanger and on a second side by the second heat exchanger. The first side and the second side intersect, it being possible for the other sides of the platform for example to be delimited by one or more ends of the body of the internal heat exchanger.

According to one feature of the invention, at least one of the heat exchangers has a length less than a length of the internal heat exchanger, so as to delimit the platform. Owing to its reduced length, the one of the heat exchangers leaves a part of the body of the internal heat exchanger free. This part left free makes it possible to position the accumulation device without mechanically interfering with the heat exchanger having a reduced length.

According to one feature of the invention, the first heat exchanger comprises a first pass configured for the refrigerant fluid to pass through it and a second pass configured for the heat transfer liquid to pass through it, the second heat exchanger comprising a first passage configured for the refrigerant fluid to pass through it and a second passage configured for the heat transfer liquid to pass through it, the internal heat exchanger comprising a first channel configured for the refrigerant fluid to pass through it at a first temperature and a second channel configured for the refrigerant fluid to pass through it at a second temperature different than the first temperature. The exchange of heat brought about within the first heat exchanger takes place between the refrigerant fluid circulating in the first pass and the heat transfer liquid circulating in the second pass. This exchange of heat may be used, for example, to condense the refrigerant fluid, thereby facilitating subsequent potential expansion. The exchange of heat may also be used to heat the heat transfer liquid in order for the latter to perform a heating function for a vehicle interior.

As is the case for the first heat exchanger, the exchange of heat occurring in the second heat exchanger takes place between the refrigerant fluid circulating in the first passage and the heat transfer liquid circulating in the second passage. This exchange of heat may be brought about between the heat transfer liquid and the expanded refrigerant fluid in order to cool the heat transfer liquid so that the latter can subsequently cool the components of the powertrain of the vehicle.

The internal heat exchanger is configured to bring about an exchange of heat between the refrigerant fluid circulating in the first channel and the refrigerant fluid circulating in the second channel. As described above, this exchange of heat brought about within the internal heat exchanger makes it possible to optimize the thermal regulation of the refrigerant fluid. It is the temperature difference between the first temperature and the second temperature that makes it possible to bring about this exchange of heat correctly.

According to one feature of the invention, at least the first pass of the first heat exchanger and at least the first channel of the internal heat exchanger form a first section configured to cause the refrigerant fluid to circulate at the first temperature. The first section extends between a refrigerant fluid inlet of the heat treatment module and ends when the refrigerant fluid switches to the second temperature, for example via an expansion member. The first section therefore corresponds to the section where the refrigerant fluid circulates at the highest temperature, which corresponds to the first temperature.

The first heat exchanger can thus make it possible both to condense the refrigerant fluid and possibly to heat the heat transfer liquid in order that the latter performs a heating function for the vehicle interior if the associated heat treatment system has a configuration of the indirect heat pump type.

The internal heat exchanger also makes it possible to cool the refrigerant fluid circulating at the first temperature by virtue of exchanging heat with the refrigerant fluid circulating at the second temperature.

According to one feature of the invention, at least the first passage of the second heat exchanger, at least the second channel of the internal heat exchanger and at least the accumulation device form a second section configured to cause the refrigerant fluid to circulate at the second temperature. The second section ensures the circulation of the refrigerant fluid at a low temperature, corresponding to the second temperature. The circulation of refrigerant fluid in the first passage thus makes it possible to cool the heat transfer liquid circulating in the second passage while still evaporating the refrigerant fluid.

The cooled heat transfer liquid can subsequently circulate out of the heat treatment module in order to cool the components of the powertrain of the vehicle or within an exchanger installed in the HVAC to cool the air in the vehicle interior. The refrigerant fluid circulating in the second section also circulates within the second channel of the internal heat exchanger, in order to contribute to the exchange of heat taking place in the internal heat exchanger as mentioned above. The accumulation device is also integrated in the second section, which stores the refrigerant fluid that has not evaporated during the exchange of heat brought about within the second heat exchanger.

According to one feature of the invention, the heat treatment module comprises an expansion member secured to the first heat exchanger and the second heat exchanger. The expansion member separates the first section from the second section within the heat treatment module.

The expansion member ensures expansion of the refrigerant fluid corresponding to a reduction in the pressure. This expansion can be made easier by the exchange of heat brought about within the first heat exchanger, which contributes to condensing the refrigerant fluid.

The expansion of the refrigerant fluid is accompanied by a reduction in the temperature. It is therefore the expansion member that makes it possible to change the temperature of the refrigerant fluid from the first temperature to the second temperature and as a result separates the first section from the second section.

The expansion member is mechanically secured to at least two heat exchangers in order to integrate it in the heat treatment module. Depending on the positioning of the expansion member at the heat treatment module, the expansion member ensures a fluidic connection between the two heat exchangers, or between one of the heat exchangers and the internal heat exchanger.

According to one feature of the invention, the first heat exchanger and the second heat exchanger each comprise a heat exchange unit at the end of which is disposed an upper wall for the first heat exchanger and an upper face for the second heat exchanger, the expansion member being disposed at the upper wall of the first heat exchanger and the upper face of the second heat exchanger, the upper wall of the first heat exchanger and the upper face of the second heat exchanger being situated opposite the internal heat exchanger with respect to the heat exchange unit of at least one of the heat exchangers. This is a first arrangement example for the expansion member within the heat treatment module according to the invention. The heat exchange unit corresponds to a structural zone of each of the heat exchangers within which the exchange of heat that is specific to it takes place. The expansion member, for its part, is arranged so as to be mechanically connected both to the upper wall of the first heat exchanger and to the upper face of the second heat exchanger. The two heat exchangers may, for example, be in contact with the internal heat exchanger, the upper wall of the first heat exchanger and the upper face of the second heat exchanger corresponding to the oppositely situated part with respect to the heat exchange unit.

According to one feature of the invention, the first heat exchanger comprises an additional pass, the expansion member ensuring a direct fluidic connection between the additional pass of the first heat exchanger and the first passage of the second heat exchanger. The additional pass makes it possible to fluidically connect the first channel of the internal heat exchanger to the expansion member, passing through the first heat exchanger via the additional pass. By contrast to the first pass, there is no exchange of heat with the refrigerant fluid circulating in the additional pass. This additional pass thus enables a connection between the first channel of the internal heat exchanger and the first passage of the second heat exchanger, passing through the expansion member.

According to one feature of the invention, the second channel of the internal heat exchanger extends as far as the platform of said internal heat exchanger, the accumulation device being fluidically connected to the second channel of the internal heat exchanger via an intermediate channel formed within the platform. The intermediate channel makes it possible to circulate the refrigerant fluid between the second channel and the accumulation device within the very structure of the platform. It will thus be understood that the platform may have a function of fluidic connection to the accumulation device, in addition to performing its function of mechanically holding the accumulation device.

According to one feature of the invention, the platform of the internal heat exchanger comprises an end piece interacting with the accumulation device, the end piece contributing to the fluidic connection between the intermediate channel of the internal heat exchanger and the accumulation device. The end piece thus makes up one end of the intermediate channel, and may for example protrude from the platform such that the accumulation device can be fitted there. The refrigerant fluid thus enters the accumulation device via its bottom.

According to one feature of the invention, the first heat exchanger and the second heat exchanger form an assembly, the expansion member being disposed within a space interposed between the assembly formed by the heat exchangers and the internal heat exchanger. This is a second arrangement example for the expansion member within the heat treatment module according to the invention. The space formed between the assembly of the two heat exchangers and the internal heat exchanger makes it possible to accommodate the expansion member and also elements ensuring, for example, a fluidic connection between the assembly of the heat exchangers and the internal heat exchanger.

According to one feature of the invention, the space accommodates a joining unit ensuring a fluidic connection between the first pass of the first heat exchanger and the first channel of the internal heat exchanger. After having contributed to the exchange of heat within the first heat exchanger, the refrigerant fluid has to go to the first channel of the internal heat exchanger. It is the joining unit that allows the refrigerant fluid to pass through the space between the assembly of the heat exchangers and the internal heat exchanger. In this regard, the joining unit may comprise a duct extending within its internal structure in order to ensure the circulation of the refrigerant fluid.

According to one feature of the invention, the space accommodates at least one joining element contributing to a fluidic connection between the accumulation device and the internal heat exchanger. Advantageously, the space accommodates two joining elements that respectively enable entry into the internal heat exchanger and then exit from the internal heat exchanger, the latter marking the end of the second section of the heat treatment module.

The accumulation device is arranged between the first passage of the second heat exchanger and the joining element enabling access to the second channel of the internal heat exchanger.

As mentioned above, the accumulation device is arranged so as to store the refrigerant fluid in the liquid state after the latter has been at least partially evaporated during the exchange of heat taking place in the second heat exchanger.

According to one feature of the invention, at least one heat exchanger is a plate exchanger comprising a first terminal plate and a second terminal plate between which a stack of plates is disposed, the expansion member being secured to at least one of the terminal plates. Like the internal heat exchanger, the heat exchangers may also be plate exchangers, the refrigerant fluid and the heat transfer liquid circulating within the heat transfer units of each of the heat exchangers and circulating between the plates forming said heat exchangers.

“Terminal plates” is understood to mean the two plates at the ends of the heat exchange unit. In other words, it means the two plates that are not framed on either side by two adjacent plates. As a result, if one of the heat exchangers is a plate exchanger, the expansion member is secured to one of the terminal plates of these one or more heat exchangers.

According to one feature of the invention, the expansion member is secured to the first terminal plate of each of the heat exchangers. The first terminal plate of the heat exchangers corresponds to the upper wall of the first heat exchanger and to the upper face of the second heat exchanger. In other words, the expansion member is secured at the first terminal plate of each of the heat exchangers, according to the first arrangement example for the expansion member as described above.

According to one feature of the invention, the expansion member is secured to the second terminal plate of each of the heat exchangers. The second terminal plate corresponds to that plate of each of the heat exchangers that faces toward the internal heat exchanger. It is therefore within the scope of the second arrangement example for the expansion member for the latter to be secured to the second terminal plate of each of the heat exchangers.

According to one feature of the invention, the internal heat exchanger comprises at least one end plate, the expansion member being secured to the end plate. The end plate of the internal heat exchanger corresponds to one of the two plates not framed on either side by two adjacent plates. More specifically, the end plate of the internal heat exchanger corresponds to the plate that faces toward the heat exchangers. According to the second arrangement example for the expansion member, the latter is arranged in the space between the assembly grouping together the two heat exchangers and the internal heat exchanger. The expansion member is therefore secured to the two heat exchangers and to the internal heat exchanger.

Further features and advantages of the invention will become more clearly apparent both from the following description and from several exemplary embodiments, which are given by way of nonlimiting indication with reference to the attached schematic drawings, in which:

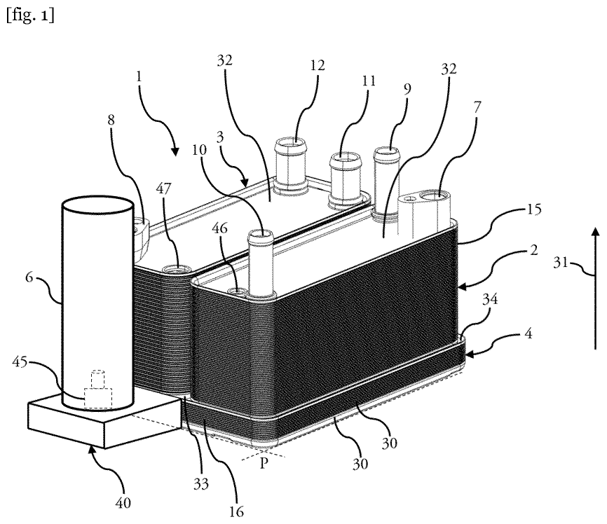

FIG. 1 shows a first embodiment of a heat treatment module according to the invention,

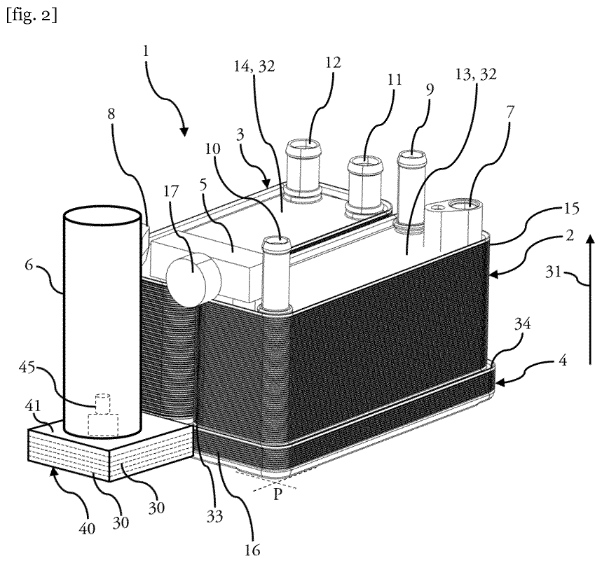

FIG. 2 shows the first embodiment of the heat treatment module provided with a first arrangement example for an expansion member integrated in the heat treatment module,

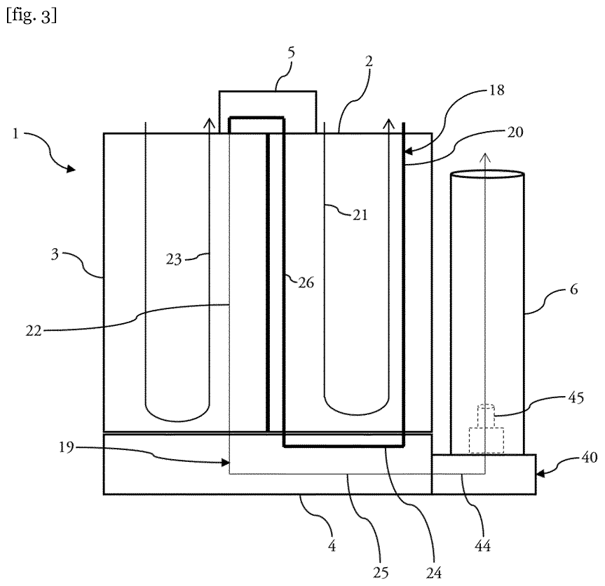

FIG. 3 shows a first circulation example for a refrigerant fluid and a heat transfer liquid within the first embodiment of the heat treatment module provided with the first arrangement example for the expansion member,

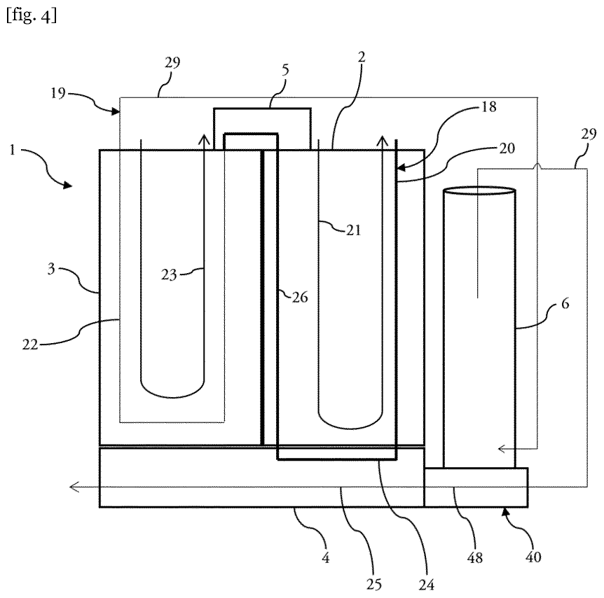

FIG. 4 shows a second circulation example for the refrigerant fluid and the heat transfer liquid within the first embodiment of the heat treatment module provided with the first arrangement example for the expansion member,

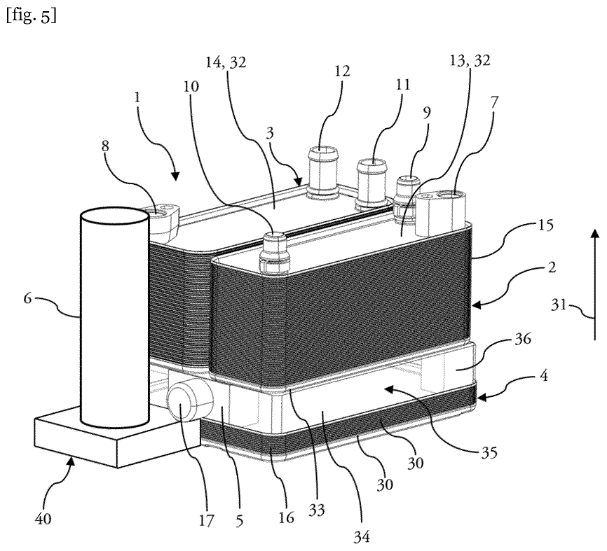

FIG. 5 shows the first embodiment of the heat treatment module provided with a second arrangement example for the expansion member integrated in the heat treatment module,

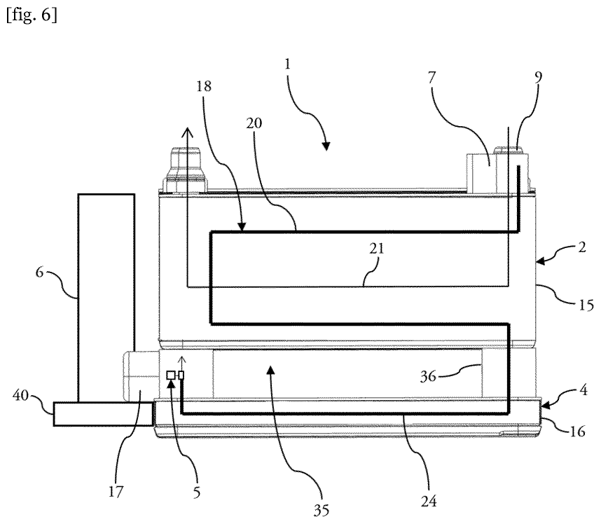

FIG. 6 shows a first part of the first or second circulation example for the refrigerant fluid and the heat transfer liquid within the first embodiment of the heat treatment module provided with the second arrangement example for the expansion member,

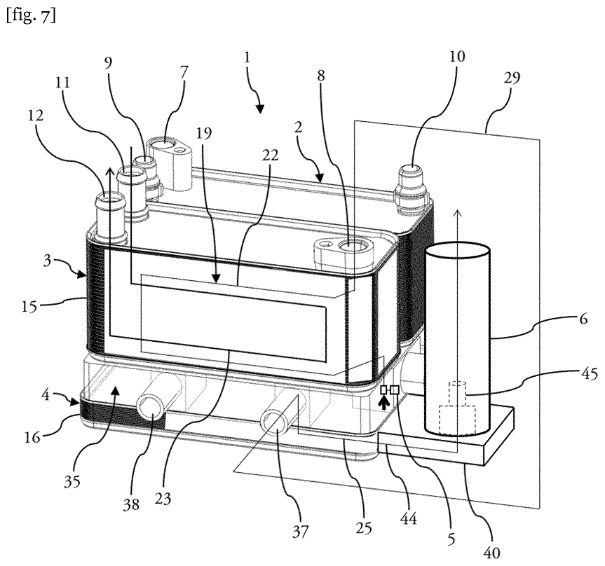

FIG. 7 shows a second part of the first circulation example for the refrigerant fluid and the heat transfer liquid within the first embodiment of the heat treatment module provided with the second arrangement example for the expansion member,

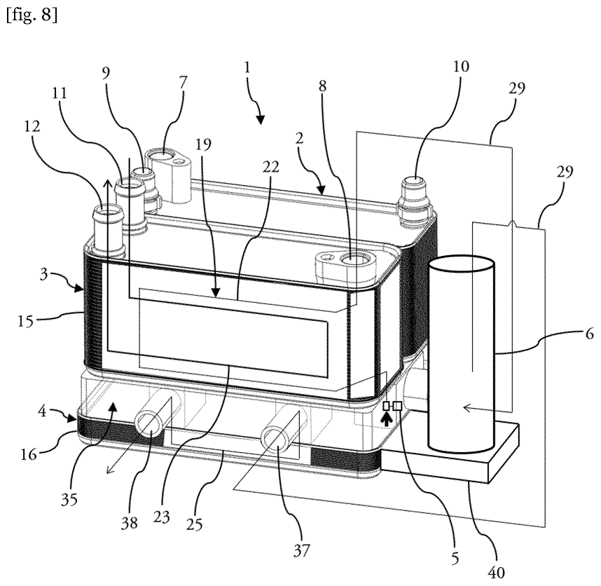

FIG. 8 shows a second part of the second circulation example for the refrigerant fluid and the heat transfer liquid within the first embodiment of the heat treatment module provided with the second arrangement example for the expansion member,

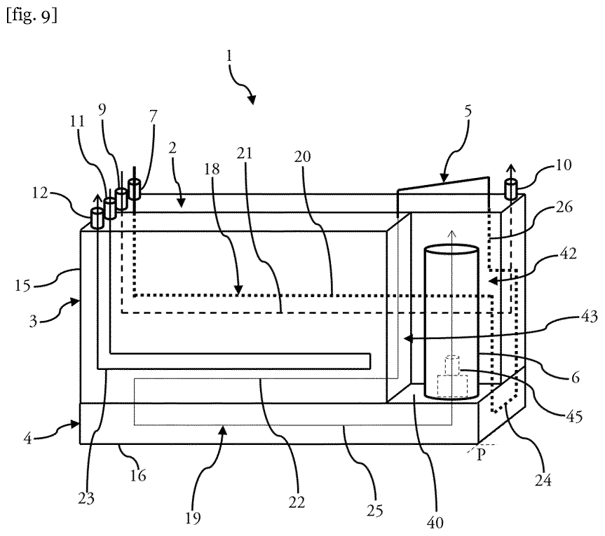

FIG. 9 shows a second embodiment of the heat treatment module according to the invention and the circulation of the refrigerant fluid and the heat transfer liquid within it, having the first arrangement example for the expansion member.

FIG. 1 shows a first embodiment of a heat treatment module 1 according to the invention.

The heat treatment module 1 forms part of a heat treatment system for a vehicle, it being possible for said system to simultaneously ensure the heat treatment of a vehicle interior and a heat treatment of various components of a powertrain of the vehicle. To this end, the heat treatment system comprises at least one refrigerant fluid circuit and at least one heat transfer liquid circuit, and the heat treatment module 1 comprises portions of these two circuits. The heat treatment module 1 is thus able to ensure the circulation of a refrigerant fluid and a heat transfer liquid within it. By way of example, the refrigerant fluid may be a fluid of the R134a or R1234yf type, and the heat transfer liquid may be glycol water.

The heat treatment module 1 groups together a first heat exchanger 2, a second heat exchanger 3 and an internal heat exchanger 4, each performing a specific function enabling the correct operation of the heat treatment system for the vehicle. As a result, the first heat exchanger 2 and the second heat exchanger 3 are configured to ensure an exchange of heat between the refrigerant fluid and the heat transfer liquid, the exchange of heat within each of the heat exchangers 2, 3 being specific to one or more functions of the heat treatment system.

Each heat exchanger 2, 3 comprises a heat exchange unit 15 within which heat is exchanged between the refrigerant fluid and the heat transfer liquid.

The internal heat exchanger 4 ensures an exchange of heat intrinsic to the refrigerant fluid circuit, but between two temperature levels of said refrigerant fluid, specifically at a first temperature and a second temperature. The details relating to the circulation of the refrigerant fluid and the heat transfer liquid and to all of the exchanges of heat taking place within the heat treatment module 1 will be described below.

In order to make the refrigerant fluid enter and exit the heat treatment module 1, the latter comprises a refrigerant fluid inlet 7 and a refrigerant fluid outlet 8. In FIG. 1, the refrigerant fluid inlet 7 is positioned at the first heat exchanger 2 and the refrigerant fluid outlet 8 is positioned at the second heat exchanger 3, but these positions may vary depending on the circulation of the refrigerant fluid within the heat treatment module 1.

Furthermore, the first heat exchanger 2 comprises a heat transfer liquid inlet 9 and a heat transfer liquid outlet 10, whereas the second heat exchanger 3 comprises an inlet orifice 11 and an outlet orifice 12. By contrast to the refrigerant fluid, the heat transfer liquid entering one of the heat exchangers 2, 3 circulates only within said heat exchanger 2, 3. As a result, the heat transfer liquid entering respectively via the heat transfer liquid inlet 9 or the inlet orifice 11 necessarily exits again via the heat transfer liquid outlet 10 or the outlet orifice 12, respectively.

The first heat exchanger 2 and the second heat exchanger 3 comprise a first connection orifice 46 and a second connection orifice 47, respectively. These connection orifices 46, 47 make it possible to fix an expansion member, as will be described below, or to fix ducts, which are themselves connected to said expansion member.

The internal heat exchanger 4 is a plate exchanger. The first heat exchanger 2 and/or the second heat exchanger 3 may also be plate exchangers. In FIG. 1, the two heat exchangers 2, 3 are plate exchangers. Each of these plate exchangers comprises a plurality of plates 30 stacked on one another along a stacking axis 31. The stacking axis 31 of the heat exchangers 2, 3 and the internal heat exchanger 4 are parallel or substantially parallel to one another.

It is the stack of plates 30 which allows the circulation of the refrigerant fluid and heat transfer liquid for the heat exchangers 2, 3, the latter circulating between the plates 30. The circulation between the refrigerant fluid and the heat transfer liquid for the heat exchangers 2, 3 and the circulation between the refrigerant fluid at the first temperature and the refrigerant fluid at the second temperature within the internal heat exchanger 4 preferably takes place alternately from one plate 30 to the next in order to optimize the exchange of heat.

The first heat exchanger 2 and the second heat exchanger 3 each comprise a first terminal plate 32 and a second terminal plate 33, each corresponding to the end plates of each of the heat exchangers 2, 3. In other words, these terminal plates 32, 33 close the heat exchange unit 15 at each of its ends. In FIG. 1, the first terminal plate 32 of the two heat exchangers 2, 3 corresponds to the plate 30 situated opposite the internal heat exchanger 4 with respect to the heat exchange unit 15, whereas the second terminal plate 33 of the two heat exchangers 2, 3 corresponds to the plate 30 facing toward the internal heat exchanger 4. The internal heat exchanger 4, for its part, comprises a body 16, which is also formed by a stack of plates 30 and is closed by an end plate 34 which corresponds to the plate 30 facing towards the two heat exchangers 2, 3.

The internal heat exchanger 4 can be inscribed in a projection P perpendicular to the stacking axis 31 of the plates 30 of said internal heat exchanger 4. It should be noted that a projection of the first heat exchanger 2 and the second heat exchanger 3 are comprised in the projection P of the internal heat exchanger 4. Such an arrangement makes it possible to improve the compactness of the heat treatment module 1.

The particular feature of the heat treatment module 1 according to the invention is that it also comprises an accumulation device 6 and a platform 40 which ensures the mechanical retention of the accumulation device 6. The accumulation device 6 is connected to the refrigerant fluid circuit and makes it possible to store some of the refrigerant fluid in the liquid state in order that the latter does not continue to circulate and damage components of the heat treatment system that can only interact with the refrigerant fluid in the gaseous state, for example a compression device, which is not shown.

According to the first embodiment of the heat treatment module, the platform 40 extends beyond the projection P of the internal heat exchanger 4. The platform 40 may for example be a part independent of the heat treatment module 1 which may be fixed thereto, for example by welding. The platform 40 may also comprise an end piece 45 protruding therefrom, on which the accumulation device 6 can be fitted in order to establish a fluidic connection between the accumulation device 6 and the platform 40.

FIG. 2 shows the first embodiment of the heat treatment module 1, but the latter is additionally provided here with an expansion member 5 secured directly to the first heat exchanger 2 and the second heat exchanger 3. Only the differences with respect to the heat treatment module 1 of FIG. 1 will be described here. Reference will therefore be made to the description of FIG. 1 for the structural and functional features shared by the heat treatment module 1 illustrated in FIG. 1 and the heat treatment module 1 illustrated in FIG. 2.

The expansion member 5 ensures the expansion of the refrigerant fluid as the latter passes through the expansion member 5. As shown in FIG. 2, the expansion member 5 is mechanically secured to the first heat exchanger 2 and the second heat exchanger 3. Such securing of the expansion member 5 may be performed, for example, by welding or by screwing. The expansion member 5 comprises an electronic controller 17 for controlling a degree of expansion of the refrigerant fluid within the expansion member 5.

The first heat exchanger 2 comprises an upper wall 13, whereas the second heat exchanger 3 comprises an upper face 14. If the first heat exchanger 2 and the second heat exchanger 3 are plate exchangers, the upper wall 13 and the upper face 14 may correspond to the first terminal plate 32 of each of the heat exchangers 2, 3. The upper wall 13 and the upper face 14 correspond to the wall and the face that are situated opposite the internal heat exchanger 4 with respect to the respective heat exchange unit 15 of each of the heat exchangers 2, 3.

According to FIG. 2, the expansion member 5 is arranged according to a first arrangement example, that is to say is secured to the upper wall 13 of the first heat exchanger 2 and to the upper face 14 of the second heat exchanger 3. The presence of the expansion member 5 within the heat treatment module 1 contributes to making the latter more compact.

The platform 40 is also different to that described in FIG. 1. This is because in this case the platform 40 is formed by a zone 41 defined by the plates 30 of the internal heat exchanger 4.

The platform is therefore not an independent part fixed to the internal heat exchanger 4 but a continuation of the plates 30 out of the projection P of the body 16 of the internal heat exchanger 4.

FIG. 3 shows a first circulation example for the refrigerant fluid and the heat transfer liquid within the first embodiment of the heat treatment module 1 provided with the first arrangement example for the expansion member. In FIG. 3, the circulation of the refrigerant fluid and the heat transfer liquid is shown by lines of different thicknesses, the thickest lines corresponding to the circulation of the refrigerant fluid within a first section 18, the thinnest lines corresponding to the circulation of the refrigerant fluid within a second section 19 and the lines of intermediate thickness corresponding to the circulation of the heat transfer liquid. As described above, the refrigerant fluid circulates in the heat treatment module 1 at two different temperatures. As a result, the refrigerant fluid circulating in the first section 18 corresponds to the refrigerant fluid at the first temperature, whereas the refrigerant fluid circulating in the second section 19 corresponds to the refrigerant fluid at the second temperature. The expansion member 5 separates the first section 18 from the second section 19 since the expansion of the refrigerant fluid causes it to switch from the first temperature to the second temperature, the first temperature being higher than the second temperature.

According to the first circulation example illustrated in FIG. 3, the refrigerant fluid enters the heat treatment module 1, more particularly a first pass 20 of the first heat exchanger 2. The first section 18, where the refrigerant fluid is at the first temperature, starts at this first pass 20. Simultaneously, the heat transfer liquid circulates within a second pass 21 of the first heat exchanger 2. The exchange of heat occurring in the first heat exchanger 2 therefore takes place between the refrigerant fluid circulating in the first pass 20 and the heat transfer liquid circulating in the second pass 21. Within the first heat exchanger 2, the refrigerant fluid is at a higher temperature than the heat transfer liquid is. The objective of this exchange of heat is notably to condense the refrigerant fluid via the heat transfer liquid in order to facilitate its expansion via the expansion member 5. This exchange of heat can also serve to heat the heat transfer liquid within the scope of a configuration of the heat pump type, which is the case for the associated heat treatment system.

After having circulated within the first pass 20, the refrigerant fluid circulates within the internal heat exchanger 4 via a first channel 24 in order to exchange heat with the refrigerant fluid circulating in the second section 19. The exchange of heat brought about within the internal heat exchanger 4 makes it possible to optimize the thermal performance of the refrigerant fluid circuit.

After having passed through the first channel 24, the refrigerant fluid returns to the first heat exchanger 2 and circulates within an additional pass 26. This additional pass 26 makes it possible to fluidically connect the first pass 24 to the expansion member 5. As a result, the refrigerant fluid circulating in the additional pass 26 does not undergo any exchange of heat, in spite of the fact that it passes through the first heat exchanger 2.

The refrigerant fluid thus goes to the expansion member 5 which, by expanding the refrigerant fluid, effects the transition between the first section 18 and the second section 19. The refrigerant fluid exits the expansion member 5 at the second temperature and circulates within a first passage 22 arranged in the second heat exchanger 3. Simultaneously, the heat transfer liquid circulates within a second passage 23 of the second heat exchanger 3. The exchange of heat occurring in the second heat exchanger 3 therefore takes place between the refrigerant fluid circulating in the first passage 22 and the heat transfer liquid circulating in the second passage 23. Within the second heat exchanger 3, the refrigerant fluid is at a lower temperature than the heat transfer liquid is. The objective of this exchange of heat is notably to cool the heat transfer liquid via the refrigerant fluid. The heat transfer liquid cooled in this way can subsequently circulate to one or more elements of the powertrain of the vehicle and to thermally treat the latter. This exchange of heat also makes it possible to at least partially evaporate the refrigerant fluid in order to optimize the performance of the refrigerant fluid circuit.

At the outlet of the first passage 22, the refrigerant fluid returns to the internal heat exchanger 4 but this time via a second channel 25. The exchange of heat brought about within the internal heat exchanger 4 therefore takes place between the refrigerant fluid circulating in the first channel 24 and the refrigerant fluid circulating in the second channel 25.

After having circulated within the second channel 25, the refrigerant fluid continues to circulate to the platform 40 and circulates as far as an intermediate channel 44 formed within the platform 40. The intermediate channel 44 is fluidically connected to the second channel 25 and ensures the circulation of the refrigerant fluid to the accumulation device 6. More particularly, the refrigerant fluid passes through the end piece 45 in order to be within the accumulation device 6. As a result, the unevaporated refrigerant fluid is kept in the bottom of the accumulation device 6, whereas the refrigerant fluid in the gaseous state is able to exit the accumulation device 6, for example via a top thereof. The refrigerant fluid thus continues to circulate out of the heat treatment module 1, for example to a compression device, which is not shown.

FIG. 4 shows a second circulation example for the refrigerant fluid and the heat transfer liquid within the first embodiment of the heat treatment module 1 provided with the first arrangement example for the expansion member. According to this second circulation example, the circulation of the refrigerant fluid within the first section 18 and the circulation of the heat transfer liquid within the heat treatment module 1 are identical to the first fluid circulation example. Reference will therefore be made to the description of FIG. 3 for the description of these parts shared by the two fluid circulation examples.

According to the second circulation example, the refrigerant fluid circulating within the second section 19 has been expanded by the expansion member 5 and circulates within the first passage 22. Subsequently, instead of extending to the internal heat exchanger 4, as described in FIG. 3, the first passage 22 extends to the refrigerant fluid outlet of the second heat exchanger 3, said refrigerant fluid outlet being illustrated in FIGS. 1 and 2.

After having exited the second heat exchanger 3, the refrigerant fluid may for example circulate within an external duct 29 to go to the accumulation device 6, which in this case does not have an end piece. As described above, the accumulation device 6 contains a potential liquid fraction of refrigerant fluid that has not been evaporated during the exchange of heat brought about in the second heat exchanger 3. As a result, a mixture of refrigerant fluid in the liquid state and in the gaseous state exits the accumulation device 6.

The refrigerant fluid then continues to circulate in the external duct 29 in order to go to the internal heat exchanger 4. Entry into the internal heat exchanger 4 may for example be effected via an additional channel 48 which is formed within the platform 40 and does not interact with the accumulation device 6. The additional channel 48 thus makes it possible to fluidically connect the external duct 29 to the second channel 25. The refrigerant fluid thus circulates within the second channel 25, thus allowing the exchange of heat with the refrigerant fluid circulating in the first channel 24. The refrigerant fluid circulating in the second channel 25 then exits the heat treatment device 1 in order, for example, to go to the aforementioned compression device, which is still not shown.

FIG. 5 shows the first embodiment of the heat treatment module 1 provided with a second arrangement example for the expansion member 5. This second arrangement example corresponds to the sole feature which differs from what was described above. Reference will now be made to the description of FIG. 1 and/or FIG. 2 as regards everything concerning the shared features described above.

The second arrangement example for the expansion member 5 is distinguished from the first arrangement example in that the heat treatment module 1 comprises a space 35 separating an assembly formed by the first heat exchanger 2 and the second heat exchanger 3 and the internal heat exchanger 4. The space 35 makes it possible to accommodate a plurality of elements, notably the expansion member 5 which is therefore interposed between the two heat exchangers 2, 3 and the internal heat exchanger 4 in this case. As a result, according to this second arrangement example, the expansion member 5 is secured to the first heat exchanger 2, the second heat exchanger 3 and the internal heat exchanger 4, for example by welding.

It can also be seen that the space 35 also accommodates a joining unit 36. The latter ensures a fluidic connection between the first heat exchanger 2 and the internal heat exchanger 4 and thus allows the refrigerant fluid to pass through the space 35.

According to the second arrangement example, the expansion member 5 is secured to the second terminal plate 33 of the first heat exchanger 2 and the second heat exchanger 3. As mentioned above, the second terminal plate 33 corresponds to the plate 30 of the first heat exchanger 2 and the second heat exchanger 3 which faces toward the internal heat exchanger 4. Since the expansion member 5 is in contact with the internal heat exchanger 4 in this case, said expansion member 5 is therefore secured to the end plate 34 of said internal heat exchanger 4.

FIG. 6 schematically illustrates the circulation of the refrigerant fluid within the first section 18 and the circulation of the heat transfer liquid within the first heat exchanger 2. This first portion of circulation of the fluids is shared by the two fluid circulation examples mentioned above. As for FIGS. 3 and 4, the fluid circulations in FIGS. 6, 7 and 8 are shown by lines of different thicknesses, the thickest lines corresponding to the circulation of the refrigerant fluid within the first section 18, the thinnest lines corresponding to the circulation of the refrigerant fluid within the second section 19 and the lines of intermediate thickness corresponding to the circulation of the heat transfer liquid.

The refrigerant fluid enters the first pass 20 of the first heat exchanger 2 via the refrigerant fluid inlet 7, whereas the heat transfer liquid enters the second pass 21 via the heat transfer liquid inlet 9. As is the case for the first arrangement example for the expansion member, the exchange of heat brought about in the first heat exchanger 2 takes place between the refrigerant fluid circulating in the first pass 20 and the heat transfer liquid circulating in the second pass 21. After this exchange of heat, the heat transfer liquid exits the first heat exchanger 2 via the heat transfer liquid outlet 10.

The refrigerant fluid, for its part, goes to the first channel 24 of the internal heat exchanger 4 via the joining unit 36 mentioned above. After having contributed to the exchange of heat brought about within the internal heat exchanger 4, the refrigerant fluid can then go directly to the expansion member 5. It will thus be understood that the second arrangement example for the expansion member 5 makes it possible to avoid installing the additional pass, as is the case for the first arrangement example. The expansion member 5 thus enables a direct fluidic connection between the first channel 24 of the internal heat exchanger 4 and the first passage of the second heat exchanger.

FIG. 7 illustrates the rest of the circulation of the refrigerant fluid according to the first circulation example, that is the second section 19 of the refrigerant fluid circuit, after the refrigerant fluid has been expanded by the expansion member 5. FIG. 7 also makes it possible to illustrate that the space 35, in addition to accommodating the expansion member 5 and the joining unit, also accommodates a first joining element 37 and a second joining element 38 allowing the refrigerant fluid to access the second channel 25 and to exit it from the outside of the heat treatment module 1.

After having been expanded by the expansion member 5, the refrigerant fluid circulates within the first passage 22 of the second heat exchanger 3. Since the refrigerant fluid is at the second temperature by circulating in the second section 19, it makes it possible to cool the heat transfer liquid circulating in the second passage 23 after having entered via the inlet orifice 11 and before exiting via the outlet orifice 12.

The refrigerant fluid, after having been at least partially evaporated during the exchange of heat brought about in the second heat exchanger 3, exits the latter via the refrigerant fluid outlet 8 and may for example circulate within the external duct 29 until it goes directly to the first joining element 37 in order to circulate within the second channel 25 such that the exchange of heat is brought about within the internal heat exchanger 4 between the first channel illustrated in FIG. 6 and the second channel 25.

After that, the refrigerant fluid circulates within the intermediate channel 44 arranged within the platform 40 and goes to the accumulation device 6 via the end piece 45. Only a very small percentage of oil and refrigerant fluid in the liquid state mixed with the refrigerant fluid in the gaseous state exits the accumulation device 6 in order to go to the compression device, which is not shown. It can thus be seen that when the refrigerant fluid circulates in the first circulation example, the second joining element 38 is not used.

FIG. 8 illustrates the rest of the second circulation example for the refrigerant fluid, that is the second section 19 of the refrigerant fluid circuit, after the refrigerant fluid has been expanded by the expansion member 5. the accumulation device 6, which in this case therefore does not have an end piece. As described above, the accumulation device 6 contains a potential liquid fraction of refrigerant fluid that has not been evaporated during the exchange of heat brought about in the second heat exchanger 3. As a result, a mixture of refrigerant fluid in the liquid state and in the gaseous state exits the accumulation device and circulates in the external duct 29 to the first joining element 37 in order to circulate in the second channel 25. The exchange of heat brought about in the internal heat exchanger 4 is performed with the refrigerant fluid circulating in the first channel, as illustrated in FIG. 6. The refrigerant fluid circulating in the second channel 25 then exits via the second joining element 38 in order to go to the compression device, which is not illustrated.

FIG. 9 shows a second embodiment of the heat treatment module 1 according to the invention and the circulation of the refrigerant fluid and the heat transfer liquid within such a heat treatment module 1. In FIG. 9, the second embodiment of the heat treatment module 1 is provided with the first arrangement example for the expansion member 5. The dotted lines correspond to the circulation of the refrigerant fluid within the first section 18 and to the circulation of the heat transfer liquid within the first heat exchanger 2. The solid lines correspond to the circulation of the refrigerant fluid within the second section 19 and the circulation of the heat transfer liquid within the second heat exchanger 3.

For this second embodiment, the platform 40 on which the accumulation device 6 is disposed is comprised in the projection P of the body 16 of the internal heat exchanger 4, by contrast to the first embodiment in which the platform 40 extends beyond the projection P of the internal heat exchanger 4. In this case, as illustrated in FIG. 9, the platform 40 can be inscribed inside a perimeter defined by the body 16 of the internal heat exchanger 4. The accumulation device 6 is also at least partially included in the projection P of the internal heat exchanger 4. As a result, the internal heat exchanger 4 does not require an intermediate channel between the second channel 25 and the accumulation device 6. Since the platform 40 is directly integrated in the body 16 of the internal heat exchanger 4, the second channel 25 may go directly to the accumulation device 6.

Because the accumulation device 6 is at least partially included in the projection P of the internal heat exchanger 4, at least one of the heat exchangers 2, 3 should have a reduced length in order not to mechanically interfere with the accumulation device 6. In FIG. 9, it is the second heat exchanger 3 which has a length less than that of the first heat exchanger 2. As a result, the platform 40 is delimited on a first side 42 by the first heat exchanger 2 and on a second side 43 by the second heat exchanger 3, the first side 42 and the second side 43 intersecting one another. The other sides of the platform 40, for their part, are delimited by the projection P of the internal heat exchanger 4.

The circulation of the refrigerant fluid and the heat transfer liquid within the heat treatment module 1 is substantially identical to that described in FIG. 3. Reference will therefore be made to the description of FIG. 3 for the description of the circulation of the various fluids within the heat treatment module 1. The sole difference comes from the fact that there is not an intermediate channel between the second channel 25 and the accumulation device 6, the second channel 25 being directly fluidically connected to the accumulation device 6.

Of course, the invention is not limited to the examples that have just been described and numerous modifications can be made to these examples without departing from the scope of the invention.

The invention, as has just been described, does indeed achieve its stated objective, and makes it possible to propose a heat treatment module grouping together two heat exchangers, an internal heat exchanger and an accumulation device. Variants that are not described here may be implemented without departing from the context of the invention, provided that, in accordance with the invention, they comprise a heat treatment module according to the invention.

1. A heat treatment module for a heat treatment system of a vehicle, the heat treatment module comprising:
a first heat exchanger,
a second heat exchanger, and
an internal heat exchanger,
wherein the first heat exchanger and the second heat exchanger both are configured to bring about an exchange of heat between a refrigerant fluid and a heat transfer liquid,
wherein the internal heat exchanger is configured to bring about an exchange of heat between the refrigerant fluid, which is subjected to two different temperature levels in the heat treatment system,
wherein the heat treatment module comprises an accumulation device configured to contain the refrigerant fluid,
the internal heat exchanger comprising a platform on which the accumulation device is disposed.

2. The heat treatment module as claimed in claim 1
wherein the first heat exchanger comprises a first pass configured for the refrigerant fluid to pass through it and a second pass configured for the heat transfer liquid to pass through it,
the second heat exchanger comprising a first passage configured for the refrigerant fluid to pass through it and a second passage configured for the heat transfer liquid to pass through it,
the internal heat exchanger comprising a first channel configured for the refrigerant fluid to pass through it at a first temperature and a second channel configured for the refrigerant fluid to pass through it at a second temperature different than the first temperature.

3. The heat treatment module as claimed in claim 2
wherein at least the first pass of the first heat exchanger and at least the first channel of the internal heat exchanger form a first section configured to cause the refrigerant fluid to circulate at the first temperature.

4. The heat treatment module as claimed in claim 3
wherein at least the first passage of the second heat exchanger, at least the second channel of the internal heat exchanger and at least the accumulation device form a second section configured to cause the refrigerant fluid to circulate at the second temperature.

5. The heat treatment module as claimed in claim 2,
the heat treatment module comprising an expansion member at least secured to the first or second heat exchanger.

6. The heat treatment module as claimed in claim 5,
wherein the first heat exchanger and the second heat exchanger each comprise a heat exchange unit at the end of which is disposed an upper wall for the first heat exchanger and an upper face for the second heat exchanger,
wherein the expansion member is disposed at the upper wall of the first heat exchanger and the upper face of the second heat exchanger,
wherein the upper wall of the first heat exchanger and the upper face of the second heat exchanger are situated opposite the internal heat exchanger with respect to the heat exchange unit of at least one of the heat exchangers.

7. The heat treatment module as claimed in claim 6,
wherein the second channel of the internal heat exchanger extends as far as the platform of the internal heat exchanger,
wherein the accumulation device is fluidically connected to the second channel of the internal heat exchanger via an intermediate channel formed within the platform.

8. The heat treatment module as claimed in claim 7,
wherein the platform of the internal heat exchanger comprises an end piece interacting with the accumulation device,
wherein the end piece contributes to the fluidic connection between the intermediate channel of the internal heat exchanger and the accumulation device.

9. The heat treatment module as claimed in claim 5,
wherein the first heat exchanger and the second heat exchanger form an assembly,
wherein the expansion member is disposed within a space interposed between the assembly formed by the heat exchangers and the internal heat exchanger.

10. The heat treatment module as claimed in claim 9,
wherein the space accommodates at least one joining element contributing to a fluidic connection between the accumulation device and the internal heat exchanger.
